(19) United States
(12) Patent Application Publication
(10) Pub. No.: US 2016/0307350 A1
(43) Pub. Date: Oct. 20, 2016

(54) VIEW SYNTHESIS - PANORAMA

(71) Applicant: Magor Communications Corporation, Ottawa (CA)

(72) Inventor: Xiaodong HUANG, Nepean (CA)

(73) Assignee: Magor Communications Corporation, Ottawa (CA)

(21) Appl. No.: 15/097,977

(22) Filed: Apr. 13, 2016

Related U.S. Application Data
(60) Provisional application No. 62/147,157, filed on Apr. 14, 2015.

(51) Int. Cl. G06T 11/60; G06K 9/46; G06K 9/62; G06T 7/00

(52) U.S. Cl. CPC G06T 11/60; G06T 7/0085; G06K 9/4604; G06K 9/6201; G06K 9/6267; G06T 7/0042; G06T 2207/20021; G06K 2009/4666; G06T 2207/20221

(57) ABSTRACT

Disclosed is a computer implemented system that facilitates optimized panoramic stitching, comprising an interface that receives images corresponding to different camera locations. Each image comprises a first image depicting a portion of a scene from the point of view of a first camera location and a second image depicting a portion of a scene from the point of view of a second camera location. There is an overlapping region detection component that detects an overlapping region between the first and second images, a first homography component that transforms the first image to the perspective of the overlapped region of the second image, an edge detection component that partitions and groups all edge pixels in the overlapped region of the first image and the second image according to their connectivity, a first transformation component that transforms each connected edge group in the first image based on initial positions of each edge group after transformation by the first homography component, a second transformation component that transforms each connected edge group in the first image after transformation from the first transformation component, a matching component that matches the transformed edge groups of the first image determined from the second transformation component with the edge pixels of the second image to produce edge matching results, and a second homography component that transforms the first image to the perspective of the second image based on the edge matching results. There is also a merger block which performs stitching to merge the two images together based on the edge matching results and the transformed image from the second homography component. The merger block performs the stitching along a border of the second image that is in the overlapped region, and the first transformation component and the second transformation component apply different transforms.

### CROSS-REFERENCE

This application claims the benefit of U.S. Provisional Application 62/147,157 filed on Apr. 14, 2015 and incorporated by reference herein.

### TECHNICAL FIELD OF THE INVENTION

The present invention relates to panorama stitching, and in particular to algorithms that construct a panorama image stream.

### BACKGROUND OF THE INVENTION

Starting with a sequence of images taken by rotating a camera located on one central point, panorama algorithms try to stitch this sequence of images together to give an extended scene for a kind of immersive experience. This concept is referred to as panorama stitching and is a topic that has been studied in both academia and industry during the past decade. The concept is also applicable to video production. By necessity, production of a video panorama requires multiple cameras. Each camera therefore views the real, three dimensional, scene from a slightly different perspective.

When the distance from a given camera to the nearest object is significantly less than the distance to the furthest object in the scene, known parallax problems arise in constructing the panorama image stream. A simplified explanation of the problem follows.

FIGS. 1, 2 and 2a illustrate the concept of panorama stitching. FIG. 1 illustrates a number of delegates 151 to 158 sitting at a table. Two cameras, 101 and 121, are more or less collocated having a different perspective of the scene but adjusted so that their respective fields of view overlap and also every delegate is within the field of view of at least one camera. Delegates 151 to 156 are within the field of camera 101. Delegates 151, 155-158 are within the field of view of camera 121.

Referring to FIG. 2a, image 201 is produced by camera 101 and image 221 is produced by camera 121, these images being single frames produced by respective cameras at about the same moment in time. Because the cameras are not on a common axis, their images are not coplanar. In this example, at least one image, e.g. 221 must be mapped 222, to produce image 223, so that it is coplanar with image 203. Image 201, redrawn for illustrative purposes, is shown overlaying the image 223.

FIG. 2b is a typical representation of the overlaid images from a simple scene. Solid lines represent the image from one camera and dotted lines represent the image from a second camera. Misalignment of these images, assuming optimum mapping 222, is primarily due to parallax cause by the fact that the two cameras necessarily have a slightly different perspective on the scene.

Production of a panoramic image must be done solely from the data in camera images 201 and 221 because no geometric data on the camera positions is available, other than the assumption that they are relatively fixed in time. That is to say mapping, determination of what constitutes the overlapped region and selection of a seam are the essence of the creation of a panoramic image.

Returning to FIG. 2a, a seam 255 is chosen such that in the final panorama image 260 pixels to the left of the seam are copied from image 201 (camera 101) and pixels to the right of the seam are copied from mapped image 223 (camera 121).

FIG. 1, which represents a top view slice of the three dimensional scene of the camera images in FIG. 2a at the height of line 261, helps understand how the various delegates will appear in the panorama. Dotted lines 103 and 123 represent the field of view of cameras 101 and 121 respectively, corresponding to the left and right hand sides of images 201 and 221/223. Chain dashed lines 105 and 125 represent the boundaries within the fields of view of respective cameras 101 and 121 corresponding to the seam 255. It will be noted that these lines necessarily intersect creating four regions in the scene labeled A to D each having distinct characteristics. Objects in regions A and B will be visible in the panorama image as intended.

It will be noted that regions C and D exist only when multiple cameras (which is a necessity in video production) having a different perspective of the scene are used. These regions do not exist in the case where a panorama photograph is constructed by pivoting a single camera about a point.

Object details in region C will not be visible at all in the panoramic image, and object details in region D will, in fact, appear twice in the panorama.

Furthermore, with multiple cameras, the mapping process 222 will be less perfect. Twisting and distortion will lead to discontinuity at the seam. The fact that the plane of mapped image 223 may not in fact be coplanar with image 260 may lead to straight lines, e.g. table edge, wall & door edges, bending at the seam.

For the above reasons panoramic video production has been much less successful than still image production. Techniques such as blurring have been used to hide edge mismatch in an unsatisfactory way and do nothing to address odd shaped tables etc.

Most panorama algorithms can be divided into two major steps—matching and stitching.

In the matching (or registration) step, corresponding pixels among images are searched. Usually feature points are extracted from each image first. Although there are many feature detection algorithms, the scale invariant feature transform (SIFT) method is commonly used in the most popular panorama algorithms and programs to detect feature points. Each feature is associated with a descriptor for iterative matching to find the corresponding feature points. With the matched feature points, a transformation—homography (eight parameters) or affine (six parameters)—is estimated based on the found corresponding pixels, using a robust algorithm RANSAC in order to reject matching outliers.

In the stitching (or fusion) step, most images are transformed to one reference image, or to the adjacent and already stitched images, according to the estimated transformations, such that a mosaic of the whole scene can be built from those images. A common problem in the stitching step is the ghosting effect, which is caused by the misalignment between images after transformations. This misalignment can be caused by errors in the matching step, scaling change, radial distortion from the camera lenses, etc., but mainly because the homography transform itself only favors co-planar scenes (in which most objects approximately lie in the same plane). If there are different objects that are both close/far to the cameras, then such misalignments will happen on either close or far objects, or both, no matter how accurate the estimated homography is. There are different methods to handle the misalignments, for example, local optical flow-based method, cutout-based method, and region-based method, etc.

Some typical problems exist in both matching and stitching steps. For the matching step, the complexity of SIFT feature matching is high, making it unsuitable for real-time panorama video applications. In addition, for some scenes which are mostly composed of un-textured surfaces, there might not be enough matched SIFT features for the estimation of homography transformations. For the stitching step, the removal of misalignments will work well if they happen within the overlapping part of the images. However, if the misaligned objects cross the overlapping/non-overlapping boundary, it may bring object distortion to the non-overlapping parts of the images.

### Current Methods—Matching Step

Usually the SIFT algorithm finds the affine invariant regions in an image and assigns descriptors to each region. Those descriptors are formed based on the histogram of gradient information (location and orientation) of each associated region. The matching of SIFT features between two images can be done by comparing their descriptors respectively. At this stage, usually the matched feature points have outliers (false matches).

With a set of matched feature points, the parameters of homography transformations can be estimated. For homography transformation, eight parameters are needed for estimation so that the pixel at (x1, y1) in the original image is transformed to (x2, y2) after homography transformation, by well-known relation.

The RANSAC algorithm can fit a model with a certain number of parameters (in this case 8 parameters) robustly according to the given matched points, while finding and rejecting the matches that are outliers in the process.

Both SIFT feature detection and matching are time-consuming and not suited to real time constraints of videoconference production. Similarly the complexity of RANSAC is also high due to its iterative nature.

### Current Methods—Stitching Step

After an image is transformed according to the estimated homographic or affine parameters, there would usually be some misalignments in the overlapped region between the transformed image and the reference image, due to the reasons stated above, i.e., homography transformations assume all the contents in the image approximately lie in one plane, and thus only favors co-planar scenes.

To address the artifacts caused by misalignments, except for the local flow-based, contour-based, and region-based methods mentioned described above, there is another method, dynamic seam finding which uses Dijkstra's algorithm to find an optimal boundary for stitching in the overlapped region, such that the misalignments along the stitching seam are minimized. However, this method, dynamic seam finding, mainly works well for stitching still panorama images. To stitch several streaming video cameras in panoramic settings, using dynamic seam finding, will bring “jumping” or “chopping” artifacts when there are objects moving across the overlapped regions, or when the misalignments happen on objects that are long enough to cross the whole overlapped regions. Because the dynamic seam will have to jump from one side of the moving to the other side as the objects moving across the overlapped region. U.S. Pat. No. 7,499,586 Agarwala et al. “Photographing big things” describes such a method.

The basic architecture of most current panorama stitching processes is shown in FIG. 3. Further improvement can be reached with more pre-processing and post-processing, as described in [1, 2], the contents of which are incorporated herein by, reference in its entirety.

To overcome the drawbacks of dynamic seam finding stated above, so that panorama stitching can be extended for the better stitching of stream panorama videos, the stitching seam needs to be fixed. But misalignments will mostly likely happen especially when the scene is non-coplanar. Therefore, a method is needed which can minimize the visual artifacts caused by misalignments. A good method to adjust part of an image is As-Rigid-As-Possible (ARAP) which is described in [3], the contents of which are incorporated herein by reference in its entirety. ARAP can move some dedicated pixels to other specific locations while keeping other non-dedicated pixels as rigid as possible so that the visual distortions caused by moving those dedicated pixels to these non-dedicated pixels are minimized.

However, to make such ARAP adjustment, one needs to know where or which pixels are needed to make adjustments. An effective way to find out such information is by using edge matching. An accurate edge matching result allows one to find out where the edge misalignments happen after homography transformations, and hence need adjustments. A paper based on such “edge matching→ARAP adjustments” scheme is already published in [4], the contents of which are incorporated herein by reference in its entirety. The edge matching part in [4] uses an existing point set matching algorithm: coherent point drift (CPD). There are some features of CPD which do not make it very suitable for edge matching between the overlapped regions of two panoramic images: CPD could not handle large amount of edge pixels (such as tens of thousands); CPD shifts all pixels even if only a very small part of edge pixels need adjustments; and CPD could not handle partial-to-partial matching in which only part of pixels in one edge group match part of pixels in another edge group.
[1] M. Brown and D. G. Lowe, “Automatic Panoramic Image Stitching Using Invariant Features,” International Journal of Computer Vision, vol. 74 no. 1 pp. 59-73, 2007.
[2] M. Brown and D. G Lowe, “Recognising Panorama,” International Conference on Computer Vision (ICCV), pp. 1218-1227, 2003.
[3] S. Schaefer, T. McPhail and J. Warren, “Image deformation using moving least squares”, ACM SIGGRAPH 2006, pages 533-540.
[4] X. Huang, S. Shirmohammadi and A. Yassine, “2×2 panoramic camera array stitching using edge matching”, Proc. International Conf. Signal Processing and Communication Systems, pages 1-10, December 2014.

### SUMMARY OF THE INVENTION

According to an aspect of the present invention, there is provided a computer implemented system that facilitates optimized panoramic stitching, comprising:
an interface that receives a plurality of images that correspond to a plurality of camera locations, the plurality of images comprising a first image depicting a portion of a scene from the point of view of a first camera location and a second image depicting a portion of a scene from the point of view of a second camera location;
an image processing component comprising:
   an overlapping region detection component that detects an overlapping region between the first and second images;
   a first homography component that transforms the first image to the perspective of the overlapped region of the second image;
   an edge detection component that partitions and groups all edge pixels in the overlapped region of the first image and the second image according to their connectivity;
   a first transformation component that transforms each connected edge group in the first image based on initial positions of each edge group after transformation by the first homography component;
   a second transformation component that transforms each connected edge group in the first image after transformation from the first transformation component;
   a matching component that matches the transformed edge groups of the first image determined from the second transformation component with the edge pixels of the second image to produce edge matching results; and
   a second homography component that transforms the first image to the perspective of the second image based on the edge matching results; and
a merger block which performs stitching to merge the two images together based on the edge matching results and the transformed image from the second homography component,
wherein the merger block performs the stitching along a border of the second image that is in the overlapped region, and
wherein the first transformation component and the second transformation component apply different transforms.

According to another aspect of the present invention, there is provided a method of panoramic stitching, comprising:

receiving a plurality of images that correspond to a plurality of camera locations, the plurality of images comprising a first image depicting a portion of a scene from the point of view of a first camera location and a second image depicting a portion of a scene from the point of view of a second camera location;

detecting an overlapping region between the first and second images and detecting edge pixels in the overlapped region for both the images;

grouping the edge pixels of the first image into individual edge groups;

transforming the edge groups of the first image to the perspective of the second image;

comparing the edge groups of the first image with the edge pixels of the second image and identifying any discrepancies as current edge matching information;

determining if current edge matching information is significantly changed from previously determined edge matching information; and

stitching the first and second images to generate a panoramic image based on the current edge matching information if the current edge matching information is significantly changed from the previously determined edge matching information, otherwise if the current edge matching information is not significantly changed from the previously determined edge matching information, the stitching is based on the previously determined edge matching information.

According to another aspect of the present invention, there is provided a method of panoramic stitching, comprising:

receiving a plurality of images that correspond to a plurality of camera locations, the plurality of images comprising a first image depicting a portion of a scene from the point of view of a first camera location and a second image depicting a portion of a scene from the point of view of a second camera location;

detecting an overlapping region between the first and second images and detecting edge pixels in the overlapped region for both the images;

determining an initial homography that transforms the first image to the perspective of the overlapped region of the second image;

grouping the edge pixels of the first image and the second image into respective edge groups;

performing a first transformation which transforms each connected edge group in the first image based on initial positions of each edge group after transformation by the initial homography;

performing a second transformation which transforms each connected edge group in the first image after the first transformation;

matching the transformed edge groups of the first image determined from the second transformation with the edge groups of the second image to produce edge matching results;

determining a second homography that transforms the first image to the perspective of the second image based on the edge matching results; and

stitching the two images together based on the edge matching results and the determined second homography,

wherein the stitching is done along a border of the second image that is in the overlapped region, and

wherein the first transformation and the second transformation apply different transforms.

According to another aspect of the present invention, there is provided a computer implemented system that facilitates optimized panoramic stitching, comprising:

an interface that receives a plurality of images that correspond to a plurality of camera locations, the plurality of images comprising a first image depicting a portion of a scene from the point of view of a first camera location and a second image depicting a portion of a scene from the point of view of a second camera location;

an image processing component that detects edge pixels in the first and second images in an overlapping region of the first and second images, and partitions and groups the edge pixels of the second image into a plurality of edge groups, each edge group being transformed to match with corresponding edge pixels of the first image,
wherein the image processing component produces edge matching information based on the transformed edge groups which is used to align the transformed second image with the first image at a perspective of the first image when the transformed second image is stitched with the first image to create a panoramic image.

According to another aspect of the present invention, there is provided a computer implemented system that facilitates optimized panoramic stitching of video frames of streaming videos, comprising:

an interface that receives a plurality of video frames from a plurality of streaming videos that correspond to a plurality of camera locations, the plurality of video frames comprising a first video frame depicting a portion of a scene from the point of view of a first camera location and a second video frame depicting a portion of a scene from the point of view of a second camera location;

an image processing component that detects edge pixels in the first and second video frames in an overlapping region of the first and second video frames, and partitions and groups the edge pixels of the second video frame into a plurality of edge groups, each edge group being transformed to match with corresponding edge pixels of the first video frame,
wherein the image processing component produces edge matching information based on the transformed edge groups which is used to align the transformed second video frame with the first video frame at a perspective of the first video frame when the transformed second video frame is stitched with the first video frame to create a panoramic video frame.

According to another aspect of the present invention, there is provided a method of panoramic stitching, comprising:

receiving a plurality of images that correspond to a plurality of camera locations, the plurality of images comprising a first image depicting a portion of a scene from the point of view of a first camera location and a second image depicting a portion of a scene from the point of view of a second camera location;

detecting edge pixels in the first and second images in an overlapping region of the first and second images;

partitioning and grouping the edge pixels of the second image into a plurality of edge groups;

transforming each edge group to match with corresponding edge pixels of the first image;

producing edge matching information based on the transformed edge groups; and

aligning the transformed second image with the first image at a perspective of the first image using the edge matching information when the transformed second image is stitched with the first image to create a panoramic image.

According to another aspect of the present invention, there is provided a method of panoramic stitching, comprising:

receiving a plurality of video frames from a plurality of streaming videos that correspond to a plurality of camera locations, the plurality of video frames comprising a first video frame depicting a portion of a scene from the point of view of a first camera location and a second video frame depicting a portion of a scene from the point of view of a second camera location;

detecting edge pixels in the first and second video frames in an overlapping region of the first and second video frames;

partitioning and grouping the edge pixels of the second video frame into a plurality of edge groups;

transforming each edge group to match with corresponding edge pixels of the first video frame;

producing edge matching information based on the transformed edge groups; and

aligning the transformed second video frame with the first video frame at a perspective of the first video frame using the edge matching information when the transformed second video frame is stitched with the first video frame to create a panoramic video frame.

The key improvements in the method are summarized as:
partition and group all edge pixels
in one image of the overlapped region, better align each edge group with their surrounding edge pixels from the other image of the overlapped region.
search for a more refined alignment for each edge group

Benefits of using the invention as described herein include:
Much fewer artifacts (misalignments, “jumping” and “chopping” effects on moving objects, etc.) along fixed stitching seam(s) in the panoramic video due to:
   Better alignment of details inside overlapped regions of the two images, especially along the fixed stitching seam
   Moving objects crossing stitching seam without “jumping” or “chopping” artifacts since the seam is fixed, so that no dynamic seam needs to jump from one side of object to another, as the objects moving across the whole stitching area
   Robust to different kinds of scenes including scenes with large non-textured areas, in which there might not be enough feature points detected for homography estimation
   Absence of bent straight lines crossing the seam
Can handle large amount of edge pixels, even in hundreds of thousands of edge pixels, efficiently.
Allows partial-to-partial matching of two edge groups, i.e. not all pixels of the two edge groups need to be involved in the matching process. This feature is very useful when the detected overlapped regions of the two images are not very precise.
Less computing resource (MIPS) by embedding motion information in following frames of the two streaming cameras.

### BRIEF DESCRIPTION OF THE DRAWINGS

FIG. 1 illustrates an exemplary configuration to describe panorama stitching.

FIG. 2a illustrates the construction of a panoramic image based on the images produced by the cameras in FIG. 1.

FIG. 2b illustrates the overlapped region of FIG. 2a.

FIG. 3 is a block diagram that illustrates the basic architecture of most current panorama algorithms.

FIG. 4 illustrates a hardware block diagram according to an embodiment of the present invention.

FIG. 5 is a flowchart depicting the overall process according to an embodiment of the present invention.

FIG. 6 is a flowchart depicting the process for producing edge matching information according to an embodiment of the present invention.

FIGS. 7a and 7b illustrate another embodiment of FIG. 2.

### DETAILED DESCRIPTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn to scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

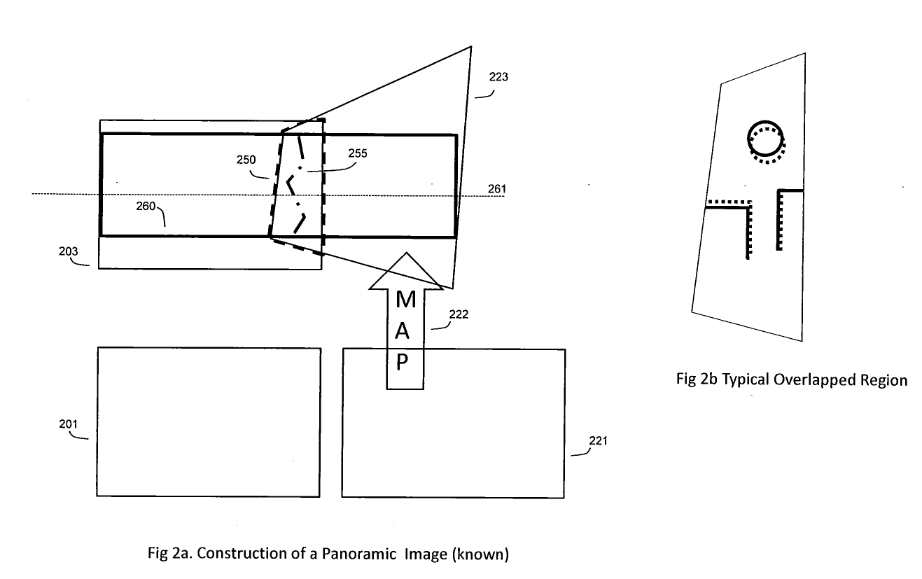

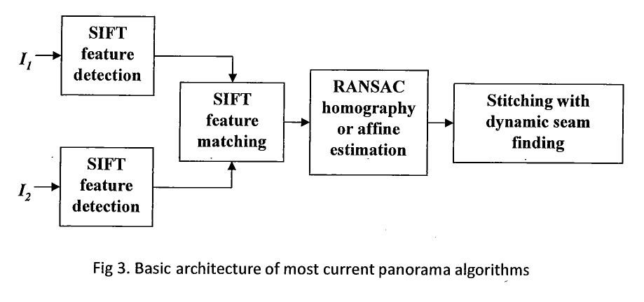

The basic ideas in our claims for edge matching can be applied to two main applications: panorama stitching and view synthesis. The main difference between these two applications is: in panorama, two or more cameras cover different parts of the scene with overlapping regions between adjacent cameras occupying, e.g. from very small to around half of the total image. And these cameras in panorama approximately share the same projection center, but there might be small baseline distance between adjacent cameras due to the physical sizes of cameras and lenses. In view synthesis, the two (or more) cameras cover mostly the same scene but from different perspectives, with two adjacent cameras approximately parallel or pointing in convergence directions, and the distance between them can range from small to wide baselines. The following description assumes panorama stitching application and assumes only two cameras are used and that the right side image 221, as shown in FIG. 2a, is only mapped into the plane of the unmapped left hand side image 201. In another embodiment of the present invention, more than two cameras can be used.

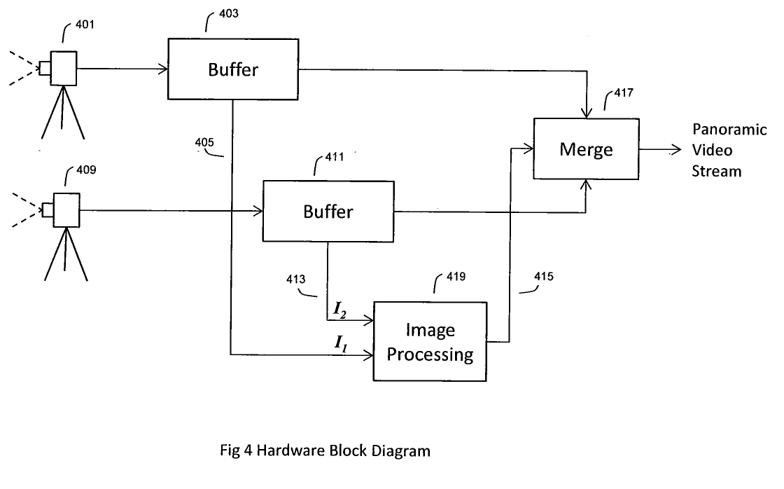

An exemplary hardware block diagram is illustrated in FIG. 4. The video output from two video cameras 401 and 409 respectively is buffered in buffers 403 and 411 respectively. Buffered video streams pass to a merger block 417 where parts of each input stream are merged according to edge matching information 415 which will be further described below.

A single frame 405 (I₁) is captured from the streaming video buffer 403 and inputted to the image processing block 419. Similarly, a single frame 413 (I₂), having a timestamp approximately the same as that of frame 405, is captured from the buffer 411 as a second input to block 419 which periodically produces edge matching information 415.

All blocks in FIG. 4, including block 419, may be implemented using software, firmware, programmable hardware, or dedicated hardware, or a combination of technologies. Software is used in this exemplary description. The arrows on the lines interconnecting the blocks indicate the direction in which the data generally flows. Conventionally, control and other signals, not shown, will flow in either direction depending on embodiment details.

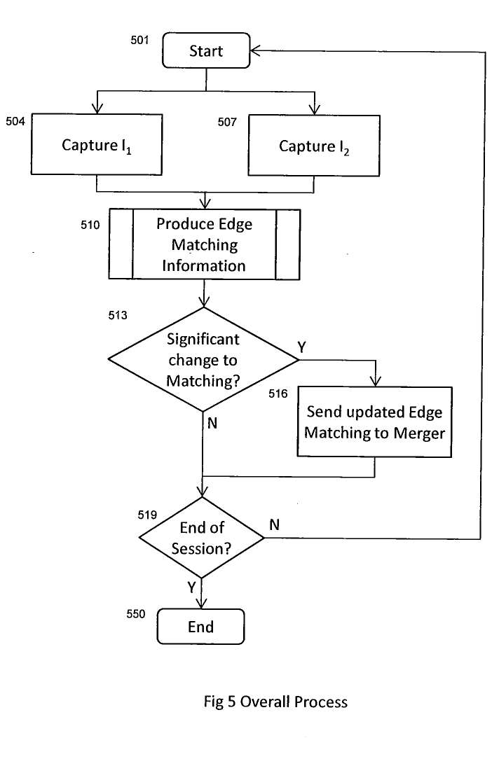

FIG. 5 is a flow chart that shows the overall process used to periodically update the edge matching information 415. Starting at 501, images I₁ and I₂ are captured from the respective input video streams. Edge matching information is produced by block 510, which is to be described later.

By means known to a person skilled in the art, for example using motion estimation inside each overlapped region of the two images, it is determined at 513 whether these matching edge pixels are significantly changed from those currently used by the merger block 417. If so, then at 516, the new edge matching information is sent to the merger block 417.

Either way, if the panoramic video session has ended, determined at 519, then the process ends 550, otherwise the process repeats starting at 501 according to a schedule appropriate to the application.

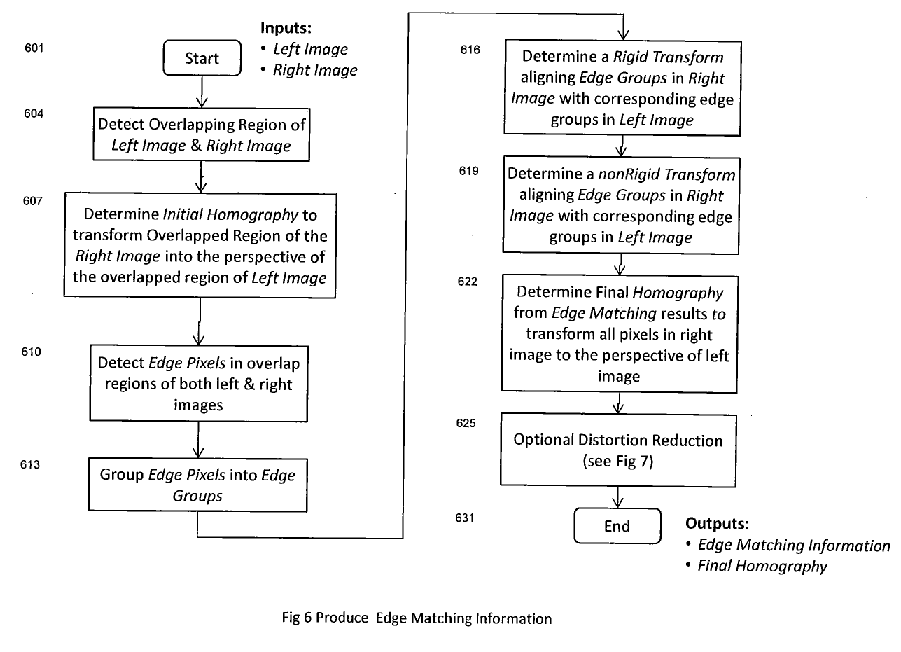

Referring now to FIG. 6 the detailed method for producing the edge matching information is described.

Inputs to the process, which starts at 601, are the left and right image frames captured from the respective video streams at approximately the same time.

A coarse common area (overlapping region) between left and right images is detected at 604 based on a known method, e.g. correlation.

At 607, an initial homography is determined. The initial homography may be a 3×3 matrix. This initial homography will approximately transform all of the pixels of the right image to the perspective of the overlapped region of the left image. This may be done by, for example, applying SURF (Speeded Up Robust Features) matching inside the overlapping regions of the two images, then estimate the initial homography according to SURF matching results. The result of the initial homography is a transformed pixel map. For example, assuming an X-Y coordinate system, a single pixel at coordinate 23, 42 is mapped using the initial homography process to coordinate 32, 50.

At 610 edge detection (using any method known to a person of ordinary skill in the art) is applied to both the left and right images to detect edge pixels of the two images. Following this, all edge pixels in the overlapped region of the right image are partitioned and grouped 613 according to their connectivity (i.e. all connected edge pixels belong to one group). The Connected Component Labeling technique, a common technique known to a person of ordinary skill in the art, could be used to accomplish this. It should be noted that the edge pixels of the left image are not partitioned and grouped, only the edge pixels of the right image. At this stage, the edge pixels in each edge group of the right image are already close to aligning with their corresponding edge pixels of the left image.

Next, the neighbouring area of each edge group as a whole will be searched in the space of the left image to determine the coordinates in the space of the left image that correspond with the edge pixels of each edge group of the right image. A zero value will be given to all detected non-edge pixels. The searching can include both a rigid and non-rigid transform as explained below with respect to steps 616 and 619.

For each edge group in the right image, based on their positions after the initial homography 607 transform, a rigid transform is performed in step 616. The 3 parameters (1 for rotation and 2 for translations) of this rigid transform are iteratively adjusted by particle swarm optimization (PSO) in which each particle is the parameter of the rigid transform (i.e. 3 particles for 3 parameters) to optimize the alignment of edge groups in the right image with corresponding edges in the left image. Following this, edge groups in the right image transformed by the initial homography 607 and then by the rigid transform 616 will be better aligned with the left image than the initial homography 607 alone. The result of the rigid transform is a further transformed pixel map. Using the single pixel example from above, after the initial homography process, the pixel is mapped to 32, 50. As a result of the rigid transform process, the pixel is then mapped to 35, 51.

Next, the previous step is repeated except that a non-rigid transform is further applied 619 to each edge group in the overlapped region of the right image transformed by the initial homography 607 and the rigid transform 616. The non-rigid transform, e.g. thin plate spline transform (TPS), is similarly optimized using the PSO method. Using the single pixel example from above, after the rigid transform process, the pixel is mapped to 35, 51. As a result of the non-rigid transform process, the pixel is then mapped to 36, 51.

In step 622, the final homography, which may also be a 3×3 transform, is estimated from an aggregate of the individual mappings from the initial homography process, the rigid transform process and the non-rigid transform process. The aggregate of the individual mappings resulting from the initial homography process, the rigid transform process and the non-rigid transform process comprise the edge matching results. The final homography is applied to the entire right image to the right of the overlapping region (non-overlapping region of the right image) to transform all the pixels in the non-overlapping region of the right image to the corresponding left image pixels.

Since this mapping process is applied to each individual edge group, it is possible that some edge groups may have alignment with their corresponding left image edge pixels after the initial homography process, but other edge groups may still have misalignment. Further transformation for better alignment may then be applied to those edge groups that still have misalignment and not those edge groups that have alignment. This avoids introducing misalignment to edge pixels that already have alignment which is possible with previous panorama stitching methods.

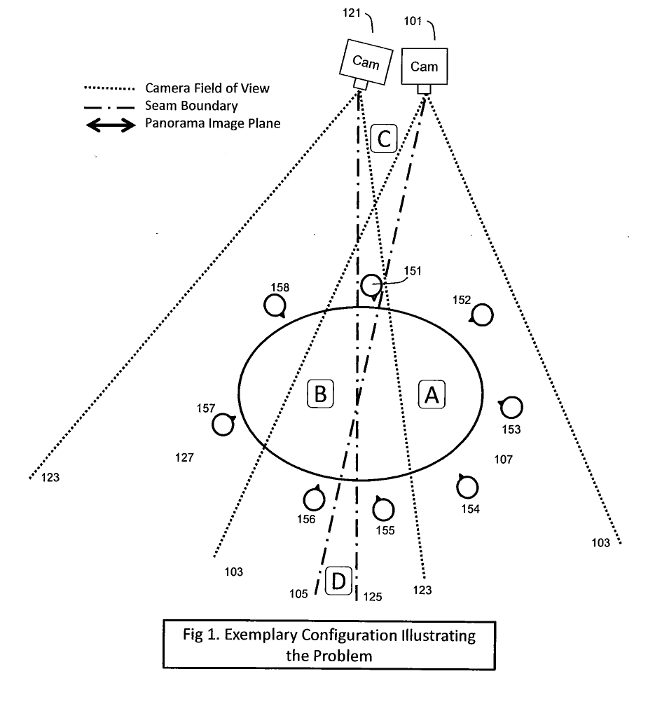

After optional step 625, to be described later, the process ends at 631 with the outputs of the process including the final homography for the first two frames of the two streaming videos and the edge matching results. The process described herein and in FIG. 6 is applied only to the overlapping region determined in step 604. However, after the maps are aggregated in step 622, this aggregate map (determined from the final homography process) is used on every frame (of one stream) in the merger block 417. Furthermore, the process described in FIG. 6 may run only once every 10 seconds but the result is applied to each and every frame of the video to merge the two (or more) video streams from the cameras into a single panoramic video stream to be transmitted to the remote end of the video conference as in the example configuration of FIG. 1.

Stitching is performed in merge block 417 along the right border of the left image as a fixed stitching seam. After the final homography process, most, if not all of the edge pixels of the left and transformed right image in the overlapping region should be aligned well. However, there still may be some edge pixel misalignment. The ARAP technique is used with the edge matching results to adjust the edge pixels in the transformed right image 223 (after final homography) so that any misalignments along the fixed stitching seam that exist after the final homography process has been applied to the right image are minimized for better visual quality.

Under certain circumstances distortion inherent in the method described so far disclosed can be undesirable. The distortion, caused by the perspective of the cameras in relation to the scene, increases toward the edges of the final panoramic image. It would be desirable to make objects near the edges (e.g. right hand side) look more ‘normal’.

FIG. 2a illustrates an example of the construction of a final panorama image 260. In this example the distortion in point is most noticeable in the right portion of the panorama contributed by mapping image 221 (produced by camera 121). That is the portion of the panorama to the right of the seam 255 or the right hand side of the left image 203 (which is identical to image 201 produced by camera 101).

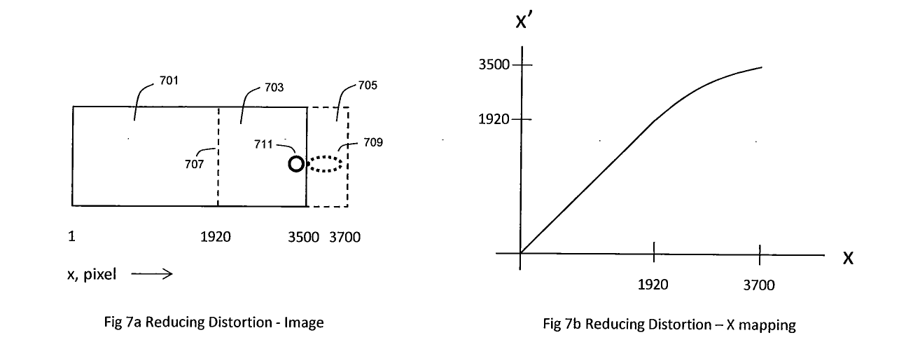

For the purposes of illustrating this embodiment, the relevant features of FIG. 2a are redrawn in FIG. 7a. Prior to applying the improvement the final panorama comprises a left hand region 701 derived from camera 101 and a right hand region 705 derived from camera 121 (regions 701 and 705 correspond to images 203 and 223 in FIG. 2a after cropping). The seam 707 corresponds to the right side of the left region 701. It will be understood that a portion to the left side of the right image 705 has been cropped according to the principle invention.

In an illustrative scene is a roughly circular object resulting in the ellipse 709, shown dotted. It has been stretched horizontally.

According to this embodiment, this region 705 will be ‘shrunk’ into narrower region 703 using the method described below. Typical X-pixel points are given for the panorama with the origin (x=1) at the left hand side. The right most pixel of region 701 is x=1920 (i.e. HD video), the far right pixel of the panorama prior to improvement is x=3700 (arbitrary). After applying the improvement, the x axis values of region 705 pixels are progressively reduced so that the pixels at x=3700 will now be at x=3500 (arbitrary). In consequence the circular object in the scene appears roughly circular 711.

This progressive reduction is further illustrated in the x-mapping graph FIG. 7b. This shows that pixels with an x value up to 1920 are not affected by the improvement. Pixels with x value greater than 1920 are progressively reduced in value so that pixels with x value 3700 have a mapped x value of 3500.

More precisely the embodiment is implemented in an additional step 625 is added to the flow chart illustrated in FIG. 6 after 622 and before the end 631 as an adjustment to the Final Homography.

Mathematically the preferred method of progressive reduction is described in the below.

Suppose (x₁, y₁) is a pixel in the original right image (image 221 in FIG. 2a), (x₂, y₂) is its homography transformed coordinates in the unimproved region 705, the following formula is used to further transfer (x₂, y₂) into (x₃, y₃) into region 703:

x₃=x₂−w*Δ where w=(x₂−1920)/(3700−1920), Δ=3700−3500,

and

y₃=y₂.

Using this, one can ‘squeeze’ 705 into 703, with right border of 705 to the right border of 703, whereas the left border of both images (i.e. 707) not changed.

Overall, the method described in this section can be seen as a nonlinear adjustment to the visual distortion caused by straight homography transform.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims.

What is claimed is:

1. A computer implemented system that facilitates optimized panoramic stitching, comprising:
an interface that receives a plurality of images that correspond to a plurality of camera locations, the plurality of images comprising a first image depicting a portion of a scene from the point of view of a first camera location and a second image depicting a portion of a scene from the point of view of a second camera location;
an image processing component comprising:
an overlapping region detection component that detects an overlapping region between the first and second images;
a first homography component that transforms the first image to the perspective of the overlapped region of the second image;
an edge detection component that partitions and groups all edge pixels in the overlapped region of the first image and the second image according to their connectivity;
a first transformation component that transforms each connected edge group in the first image based on initial positions of each edge group after transformation by the first homography component;
a second transformation component that transforms each connected edge group in the first image after transformation from the first transformation component;
a matching component that matches the transformed edge groups of the first image determined from the second transformation component with the edge pixels of the second image to produce edge matching results; and
a second homography component that transforms the first image to the perspective of the second image based on the edge matching results; and
a merger block which performs stitching to merge the two images together based on the edge matching results and the transformed image from the second homography component,
wherein the merger block performs the stitching along a border of the second image that is in the overlapped region, and
wherein the first transformation component and the second transformation component apply different transforms.

2. The system of claim 1, wherein the first image is a right image of the scene and the second image is a left image of the scene.

3. The system of claim 1, further comprising two cameras, wherein each camera is at a respective camera location.

4. The system of claim 1, wherein the overlapping region detection component detects the overlapping region between the first and second images by correlation.

5. The system of claim 1, wherein the first homography component applies speeded up robust features (SURF) matching inside the overlapping region comprising the two images then estimates an initial homography based on the SURF matching.

6. The system of claim 1, wherein the edge detection component applies connected component labeling to partition and group all edge pixels in the overlapped region of the first image according to their connectivity.

7. The system of claim 1, wherein the second transformation component uses a non-rigid transform.

8. The system of claim 1, wherein the merger block uses an as-rigid-as-possible (ARAP) technique with the edge matching results to adjust the edge pixels in the transformed first image determined by the second homography component.

9. A method of panoramic stitching, comprising:
receiving a plurality of images that correspond to a plurality of camera locations, the plurality of images comprising a first image depicting a portion of a scene from the point of view of a first camera location and a second image depicting a portion of a scene from the point of view of a second camera location;
detecting an overlapping region between the first and second images and detecting edge pixels in the overlapped region for both the images;
grouping the edge pixels of the first image into individual edge groups;
transforming the edge groups of the first image to the perspective of the second image;
comparing the edge groups of the first image with the edge pixels of the second image and identifying any discrepancies as current edge matching information;
determining if current edge matching information is significantly changed from previously determined edge matching information; and
stitching the first and second images to generate a panoramic image based on the current edge matching information if the current edge matching information is significantly changed from the previously determined edge matching information, otherwise if the current edge matching information is not significantly changed from the previously determined edge matching information, the stitching is based on the previously determined edge matching information.

10. The method of claim 9, wherein the first image is a right image of the scene and the second image is a left image of the scene.

11. The method of claim 9, wherein the system further comprises two cameras.

12. The method of claim 9, wherein the step of detecting detects the overlapping region between the first and second images by correlation.

13. The method of claim 9, wherein the step of grouping applies connected component labeling to partition and group all edge pixels in the overlapped region of the first image according to their connectivity.

14. The method of claim 9, wherein the step of determining if current edge matching information is significantly changed from previously determined edge matching information uses motion estimate inside each overlapped region of the two images.

15. A method of panoramic stitching, comprising:
receiving a plurality of images that correspond to a plurality of camera locations, the plurality of images comprising a first image depicting a portion of a scene from the point of view of a first camera location and a second image depicting a portion of a scene from the point of view of a second camera location;
detecting an overlapping region between the first and second images and detecting edge pixels in the overlapped region for both the images;
determining an initial homography that transforms the first image to the perspective of the overlapped region of the second image;
grouping the edge pixels of the first image and the second image into respective edge groups;
performing a first transformation which transforms each connected edge group in the first image based on initial positions of each edge group after transformation by the initial homography;
performing a second transformation which transforms each connected edge group in the first image after the first transformation;
matching the transformed edge groups of the first image determined from the second transformation with the edge groups of the second image to produce edge matching results;
determining a second homography that transforms the first image to the perspective of the second image based on the edge matching results; and
stitching the two images together based on the edge matching results and the determined second homography,
wherein the stitching is done along a border of the second image that is in the overlapped region, and
wherein the first transformation and the second transformation apply different transforms.

16. The method of claim 15, wherein the first image is a right image of the scene and the second image is a left image of the scene.

17. The method of claim 15, wherein the step of detecting an overlapping region detects the overlapping region between the first and second images by correlation.

18. The method of claim 15, wherein the initial homography applies SURF matching inside the overlapping region comprising the two images then estimates an initial homography based on the SURF matching.

19. The method of claim 15, wherein the step of grouping applies connected component labeling to partition and group all edge pixels in the overlapped region of the first image according to their connectivity.
